(19) United States
(12) Patent Application Publication
(10) Pub. No.: US 2009/0099979 A1
(43) Pub. Date: Apr. 16, 2009

(54) Systems and methods for enhancing group benefit plans and other entities via life insurance funding and administration structures

(76) Inventors: Harish Raghavan, New York, NY (US); Edward Netherland, Lascassas, TN (US)

Correspondence Address: MCDERMOTT WILL & EMERY LLP, 600 13TH STREET, N.W., WASHINGTON, DC, 20005-3096, US

(21) Appl. No.: 12/287,437

(22) Filed: Oct. 9, 2008

Related U.S. Application Data
(60) Provisional application No. 60/998,130, filed on Oct. 9, 2007.

(51) Int. Cl. G06Q 40/00

(52) U.S. Cl. 705/36 R; 705/4

(57) ABSTRACT

The present inventions provide improved funding and administrative arrangements for increasing the amount of income available for group benefit plans, unions, VEBAs, and other entities designed to aggregate funds for the benefit of a selected population. In general, the arrangement includes an insurance component and a financing component and may be bankruptcy-remote from the group benefit plan and its sponsor. The financing component may be combined with the insurance component in order to create and capture value by obtaining comparatively inexpensive capital market funding to generate a favorable economic outcome for the plan, its participants and/or certain specified beneficiaries. The financing component may be selected such that it is capable of paying premiums associated with the insurance component and funding other aspects of the arrangement.

### PRIORITY CLAIM

This application claims priority from U.S. provisional application Ser. No. 60/998,130 filed Oct. 9, 2007.

### BACKGROUND OF THE INVENTION

The present inventions generally relate to systems and methods for the enhancement of group benefit plans and other suitable entities. More specifically, the present inventions relate to systems and methods that generate value through a favorable combination of life insurance policies with other financial instruments such as annuities or a related type of cash flow instrument. The combination of these insurance and/or financial products provide opportunities for increased income to group benefit plans such as pensions, unions, voluntary Employees' Beneficiary Associations (“VEBAs”), and other trusts authorized by Internal Revenue Code and other entities.

In the life insurance industry, as in many other markets, there are opportunities to create and capture value associated with the combination of different types of financial products involving disparate cash flows and investments. For a given insurance product, such as life insurance policies, there is often a wide range of prices and underwriting classes available. Within this range, there will be companies offering more attractive life insurance policy contracts, as well as companies offering more attractive annuities or related type of cash flow instruments. If such insurance policies and cash flow instruments are carefully selected and purchased in tandem, there is an opportunity to create value by obtaining comparatively inexpensive capital market funding and realize a cash flow in excess of the related capital market funding cost. One example is the combination of a life insurance policy with an annuity contract.

For example, an individual may have $1,000,000 and may place this money in a low-risk bond or cash fund and earn about a 4% return (i.e., about $40,000 per year). Using the strategy described above, however, the same individual may place the $1,000,000 into an annuity that pays $140,000 per year and secure a $1,000,000 life insurance policy for $60,000 per year in premiums. With this approach, the life insurance premium can be paid from the annuity, leaving the individual with a net income of $80,000 per year. This net income of $80,000 is double the amount that the low-risk fund would have provided. In addition, the original capital of $1,000,000 is preserved with the life insurance in that the life insurance policy pays $1,000,000 upon the death of the individual. This preservation of principal is similar to the low-risk fund scenario in that the low-risk fund also preserves the original $1,000,000 principal. Using this combination arrangement, the individual enjoys increased income until their death, and still passes on the initial $1,000,000 to beneficiaries by way of the life insurance death benefit.

Within this class of products is the Life Insurance and Life Annuities-backed Charitable Securities (LILACS), which specifically seek to create and capture value in the interplay between life insurance, annuity policies and capital market funding for the benefit of charitable organizations.

In general, several factors contribute to the difficulty of creating and capturing value between life insurance and annuity (or related type of cash flow instrument) through an investment entity. First, the pricing and terms at which life insurance products are offered typically limits successful combination structures to individuals within a certain age group. For individuals outside of this range, the cost of life insurance premiums, payments to capital market security holders, and other expenses usually exceeds the amount paid out by the cash flow instrument.

Second, purchases of such insurance products are limited by insurance laws such as insurable interest rules and life settlement laws. Although an individual can designate oneself as the beneficiary of a life insurance policy, the scope of other allowed beneficiaries is generally restricted to those which are deemed to have an “insurable interest” in the insured. Thus, an entity such as a trust may not be able to purchase insurance on the lives of individuals for whom such a structure may otherwise succeed.

In spite of such difficulties, and in compliance with applicable laws, a series of successful LILACS transactions were performed by UBS and Lilac Capital, LLC in 2003 and 2004 for the benefit of various charities. In the states where the transactions occurred, charitable organizations were deemed to have “insurable interest” on the lives of donors, thus allowing for the purchase of insurance on the lives of certain consenting individuals.

In each LILACS transaction, a transaction-specific trust sold securities in the capital markets for an amount which was slightly less than the total death benefit amount to be obtained from the life insurance policies by the eventual death of the respective donors. The proceeds from the sale of these securities were used by the trust to purchase immediate life contingent annuities on the lives of the donors, as well as make initial life insurance premium payments. Continuing annuity payments were sufficient to pay ongoing life insurance premiums, make monthly payments to the capital market securities holders and cover administrative costs. Death payments were sufficient to return the original capital contributed into the transaction by the capital market securities holders, and still have funds remaining for the benefit of the charitable organization designated by the insured.

Although the above LILACS transactions were profitable, they were limited in many respects. First, the pool of insured individuals was very small, in part due to (a) the limited number of candidates interested in donating to charitable organizations in general, and (b) only a small number of this group was interested in donating by way of life insurance. To mitigate this issue, high net worth individuals were selected who each could obtain substantial death benefits —a strategy which is generally not applicable to more diverse insurable populations.

Second, there is a limited number of jurisdictions in which a trust not set up by the insured has the recognized “insurable interest” needed to purchase the necessary insurance products. Finally, the transactions did not offer a direct benefit, outside of the satisfaction of having donated, to those whose lives were insured. Instead, the transaction relied on the charitable nature of insured individuals to encourage participation. The charity received the benefit from the transaction in the form of the residual death benefit proceeds.

Accordingly, it would be desirable to provide systems and methods that overcome the deficiencies of the prior art and allow broader consumer access to the general insurance combination strategy described above.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 illustrates the initial set up of a funding and administrative structure that may be used to enhance group benefit plans and other suitable entities.

FIG. 2 illustrates the distribution of funds for ongoing operations for the funding and administrative structure of FIG. 1.

FIG. 3 illustrates the distribution of funds for termination of the funding and administrative structure of FIG. 1 with respect to a single insured individual.

FIG. 4 illustrates some of the steps involved in a computer implemented embodiment of the present invention as illustrated in FIGS. 1-3.

### SUMMARY OF THE INVENTION

It is contemplated that the subject matter described herein may be embodied in many forms. Accordingly, the embodiments described herein are provided to illustrate and convey the present inventions to one of ordinary skill in the art, and are not to be considered limitations.

The present inventions provide improved funding and administrative arrangements for group benefit plans such as pensions, unions, VEBAs, and other qualifying entities. In general, the arrangement includes insurance and financing components, which may be combined in order to create and capture value for the group benefit plan, its participants and/or certain specified beneficiaries. The financing component may be selected such that it is capable of paying premiums associated with the insurance component and funding other aspects of the invention.

Moreover, preferred embodiments of the present invention provide systems and methods that allow these results to be achieved in compliance with existing state and federal regulations and without exposing the plan and its participants to substantial additional financial risk. Funding may be obtained from the capital markets (such as the fixed income or equity markets) to purchase the combination of life insurance and financial product.

One specific embodiment of the present invention is directed towards systems and methods for providing income to a group benefit plan, such as a pension, which improves the overall financial strength of such group benefit plan. More specifically, a special purpose vehicle (“SPV”), such as a statutory trust, may be created by the sponsoring pension. The SPV then procures life insurance policies on the lives of certain participating pensioners. The SPV may assign the death benefit of these life insurance policies to a second entity, such as a financing trust, in exchange for funding necessary to pay the premiums on the life insurance policies.

The arrangement between the SPV and the financing trust can either be financing (i.e., a loan) or equity in nature. Thus, the life insurance policies may be used either as collateral to obtain financing from the financing trust (which may obtain its own financing from the capital markets), or the life insurance policies can be used as the basis for an equity participation by the SPV in the financing trust.

In certain loan type transactions, the financing trust may instead be an operating and duly licensed lending institution. The life insurance policies may then be combined with a financial product such as an annuity or related cash flow instrument that generates excess cash flows as a result of the combination. If the component products are selected properly, current cash flow or the death benefit from the life insurance policy is greater than amount required for the arrangement, allowing the pension plan to capture this excess amount. This excess amount may be shared with the pensioners to incentivize participation, and/or may be used to further capitalize the pension plan or otherwise enhance benefits it provides.

In addition, the SPV and management of the arrangement may be outsourced to a third party so that the group benefit plan need not incur additional management functions as a result of implementing the arrangement. Moreover, the SPV and the second entity are both separate and bankruptcy-remote from the sponsoring group benefit plan, thereby relieving the plan of financial obligations of the SPV and/or the second entity. Conversely, neither the SPV nor the second entity are exposed to the financial obligations of the plan.

In one embodiment of the present invention, a funding and administrative entity for supplementing income to a group benefit plan, comprising a trust; a plurality of participants enrolled in the group benefit plan; one or more structured finance contracts which provide income to the trust for a predetermined period of time based on lives of the plurality of participants, wherein the trust is designated as the beneficiary of the structured finance contracts; one or more life insurance contracts that insure lives of the plurality of participants, wherein the trust is designated as the beneficiary of the life insurance contracts; and one or more security instruments issued by the trust for paying costs associated with securing the one or more annuity or structured finance contracts, and the one or more life insurance contracts, and administrative expenses; wherein the net income of the trust is transferred to the group benefit plan, and wherein the plurality of participants optionally receive a benefit associated with the net income of the trust.

Another aspect of the present invention is directed toward a computer-readable medium having stored thereon a plurality of sequences of instructions including sequences of instructions which, when executed by one or more processors cause an electronic device to select a plurality of potentially qualified group benefit plan participants based on a potential combination of structured finance and life insurance products; obtain information regarding one or more life insurance contracts on the lives of the plurality of potentially qualified group benefit plan participants; obtain information regarding one or more annuities or related cash flow instruments on the lives of the plurality of potentially qualified group benefit plan participants; and select a plurality of qualified group benefit plan participants from the plurality of potentially qualified group benefit plan participants.

### DETAILED DESCRIPTION OF THE INVENTION

The systems and methods of the present invention provide improved funding and administrative arrangements for group benefit plans without introducing additional cost. As mentioned above, the systems and methods of the present invention can be utilized by certain qualifying entities such as retirement accounts, pensions, unions and VEBAs. The group benefit plan or other qualifying entity may be pre-existing or may be designed in view of the concepts and principles described herein.

In accordance with one embodiment, the arrangement includes an insurance component and a financing component that interoperates with the sponsoring entity such as the group benefit plan so that the arrangement achieves its contemplated financial goals in compliance with existing laws and regulations. For example, the life insurance policies may be owned at inception by a statutory trust established by the group benefit plan, such as a pension plan. The group benefit plan may be sole grantor and beneficiary of the statutory trust. Nevertheless, the statutory trust is bankruptcy-remote from both the group benefit plan and the underlying company or institution that created, sponsors or administers the plan. This relieves the group benefit plan of certain administrative, legal, and financial burdens associated with applicable regulatory requirements.

The financing component may be associated with the insurance component in view of certain attributes of the group benefit plan participants in order to optimize the financial outcome for the plan, its participants and/or certain other specified beneficiaries. Generally speaking, the financing component is selected such that the arrangement is capable of paying premiums associated with the insurance component and for funding other aspects of the arrangement. Additionally, the insurance component is selected such that its benefit payout fully or partially repays capital market funding.

The financing and insurance components selected may be based on certain attributes of group benefit plan participants. For example, the financing and insurance component may be based on the health or life expectancy of plan participants and capital markets interest rate environment, and may be obtained in view of desired or projected financial criteria such as benefit payout to the group benefit plan. Generally speaking, these two components are selected such that the benefit provided by the insurance component is greater than the cost of the capital markets funding and arrangement administrative expense. Various means may be employed to maximize this differential.

In a specific embodiment, the insurance components may include life insurance and the financing component may include an annuity (e.g., structured payout contract such as a life annuity contract or single premium immediate annuity). Another example is the pairing of life insurance with a synthetic or derivative product such as a mortality swap instrument. However, it will be understood that other insurance and financing components may be selected if desired, as long as the arrangement generates income or other benefit for the group benefit plan and/or its participants and beneficiaries.

The following description uses a pension plan as the group benefit plan to illustrate the present invention, but it will be understood that any other qualifying group benefit plan or arrangement may be used, if desired.

Initially, an SPV may be formed by a pension plan, procuring life insurance policies for certain pension plan participants, and assigning the death benefit of these policies to the SPV. Under the current insurance laws of many states, pension plans have recognized “insurable interest” in existing and previous employees of the entity which sponsors the pension.

This provides a significantly large population from which a program can select potential participants for whom the arrangement will likely succeed. The program may choose to share residual cash value with a participant during their lifetime, either in the form of a cash payment, or enhanced benefits. In jurisdictions where an insured individual's consent is required, this can provide a valuable incentive for participation, leading to a larger pool of participants and thus a more robust and financially stable plan.

Initial Set Up of Program

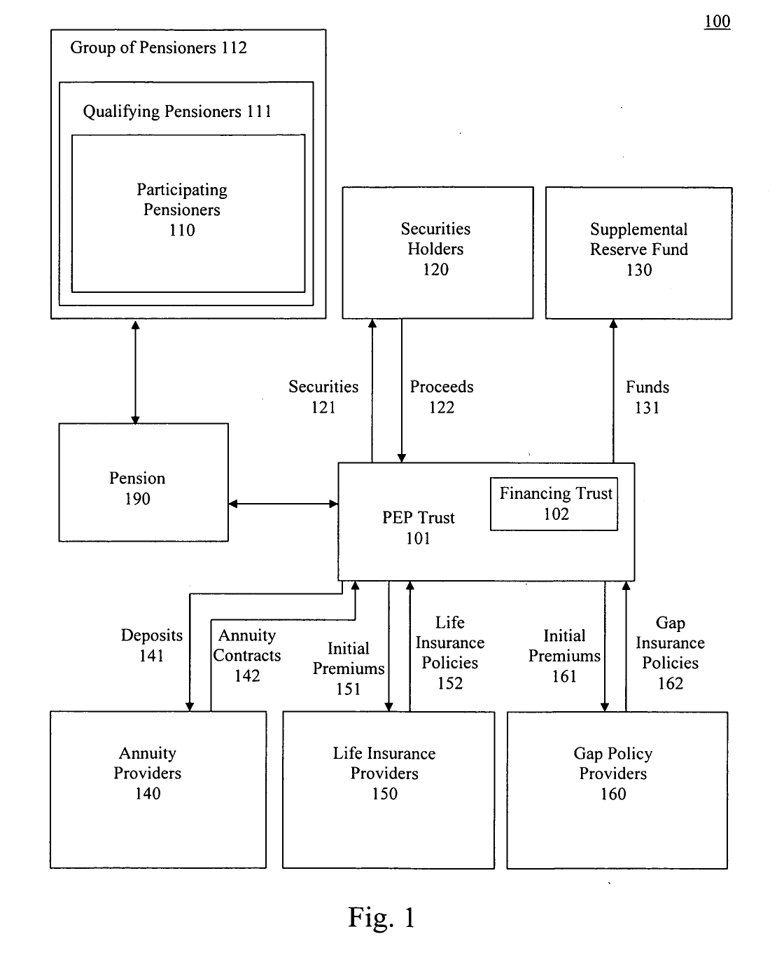

FIG. 1 illustrates an initial set up of an arrangement that provides additional benefit to a pension plan in accordance with one embodiment of the invention, and may be referred to herein as a Pension Enhancement Program 100 (“PEP”). As shown, PEP arrangement 100 may include PEP trust 101, financing trust 102, participating pensioners 110, qualifying pensioners 111, group of pensioners 112, security holders 120, and pension 190 and involve supplemental reserve fund 130, annuity provider 140, life insurance providers 150 and optionally, gap policy providers 160.

Initially, a PEP trust 101 may be established by pension 190 to manage the PEP assets which may be owned and/or controlled by securities holders 120 (or other capital source). PEP trust 101 may be a master trust such as a Delaware statutory trust, and is separate from both the entity which sponsors the pension and the pension itself. Moreover, PEP trust 101 and financing trust 102 are bankruptcy-remote from both the entity which sponsors the pension and the pension 190 itself. In some embodiments, PEP trust 101 may be an ERISA-qualified trust such that its assets are disregarded for tax purposes. In addition, PEP trust 101 may include or be associated with a financing trust 102 and may handle certain financial aspects, including some transactions with annuity provider 140, life insurance provider 150 and gap policy provider 160.

A group of qualifying pensioners 111 may be identified from the group of pensioners 110 for possible participation in PEP 100. Factors such as a pensioner's age, sex, health, and the amount of pre-existing life insurance coverage may be used to determine whether a successful life insurance/annuity combination can be arranged, in consideration of factors such as the payment rates offered by annuity products, the cost of life insurance premiums, the rate of return to be offered to securities holders 120, and other anticipated expenses for operating the PEP. Other factors may be evaluated as well. Pensioners 112 who meet the criteria for inclusion are deemed qualifying pensioners 111. From a set of qualifying pensioners 111 participating pensioners 110 are selected. Such qualifying pensioners, for example, may be in the age range of about 65-80 and in reasonable health.

In some jurisdictions, consent may be required for participation in the program. In other jurisdictions, consent may not be required for a PEP trust 101 to purchase insurance for existing and previous employees of the entity which sponsors the pension. To encourage participation in PEP 100, qualifying participants 111 may be provided with an estimated individual benefit they may receive by opting to participate. Qualifying pensioners 111 may choose to decline to participate on the basis that they desire to more fully insure themselves for their own beneficiaries, as at a certain level of total coverage it becomes more expensive or difficult to acquire life insurance, or on another basis.

The level of life insurance death benefit may be determined for each participating pensioner based on relevant market conditions, such as the cost of life insurance premiums, the payment rates offered by annuity products available for the participating pensioners, and the rate of return to be offered to securities holders in PEP. In addition, the level of life insurance may further be selected in view of certain operating, overhead or other management expenses associated with PEP 100 and the desired degree of profitability.

PEP trust 100 applies for life insurance polices 152 and is the policy owner and beneficiary. In some embodiments, life insurance policies 152 are secured through pension 190 with the consent of participating pensioners 110. The sum of the individual insurance benefits provides the aggregate insurance benefit for PEP trust 101. In general, the aggregate insurance benefit is selected to exceed costs and overhead associated with PEP 100 to generate an income, and in many instances, to maximize this income.

Based upon the aggregate insurance benefit, PEP trust 101 (or in some embodiments financing trust 102) offers securities 121 to securities holders 120. The securities may be issued through an investment bank or other financial institution (not shown). The total amount of securities 121 offered may be a function of operating expenses, the desired degree of leverage and other factors and may be approximately 95 percent of the aggregate insurance benefit (although other amounts may be used, if desired).

PEP trust 101 (or financing trust 102) collects proceeds 122 from security holders 120 which are used to fund the initial operations of the PEP trust 101.

In some embodiments, annuity contracts 142 may be secured from providers 140 by financing trust 102, which may be both the owner and beneficiary. Financing trust 102 may use the majority of proceeds 122 to pay deposits 141 on those annuity contracts 142 on the lives of participating pensioners 110. Annuity contracts 142 may be in the form of a group immediate life contingent annuity, as this often offers favorable payment rates, but it may be any other annuity product or group of products that provides a payout sufficient to fund ongoing operations of PEP trust 101.

Future payments received under annuity contracts 142 may provide an income stream for PEP trust 101 (and/or financing trust 102) guaranteed for the life of the participating pensioners 110. Also, gap insurance policies 162 may be obtained by financing trust 102 from gap policy providers 160. Financing trust 102 may be both owner and beneficiary of gap insurance policies 162. The gap insurance policies 162 may be used to cover certain risks to PEP trust 101, which may include unlikely events such as suicides, missing persons, fraud in life insurance and annuity applications, and early deaths for participating pensioners 110, for which a reduced death benefit may be received due to “ramp up” of some life insurance products.

Additionally, a supplemental reserve fund 130 may be established by PEP trust 101 or financing trust 102 to cover payments due during any periods of delay between the termination of annuity payments and payment of the death benefit associated with the death of a participating pensioner. Typically, supplemental reserve fund 130 maintains sufficient funds 131 to cover an approximately three month delay in payment of a death benefit after termination of annuity payments for a deceased participating pensioner 110. Finally, any administrative fees may be paid (including any applicable taxes and trustee fees) from the supplemental reserve fund 130.

In embodiments where insurance polices 152 are domiciled in PEP trust 101, and annuity contracts 142 and gap insurance policies 162 are domiciled in financing trust 102, it may be necessary for PEP trust 101 to contribute certain rights to life insurance policies 152 and receive a certified interest in return.

The following table is illustrative of amounts that may be allocated for a participating 70 year old male pensioner:

TABLE 1

| | |
|---|---|
| Life Insurance Death Benefit Amount | $500,000 |
| Use of proceeds from sale of $500,000 in | |
| securities | |
| Annuity Deposit | $481,000 |
| Initial Life Insurance Premium | $2,500 |
| Gap Insurance Policy and Supplemental Reserve | $10,000 |
| Fund | |
| Trustee and Other Administrative Fees | $6,500 |
| Total Use of Proceeds | $500,000 |

Ongoing Operation of Program

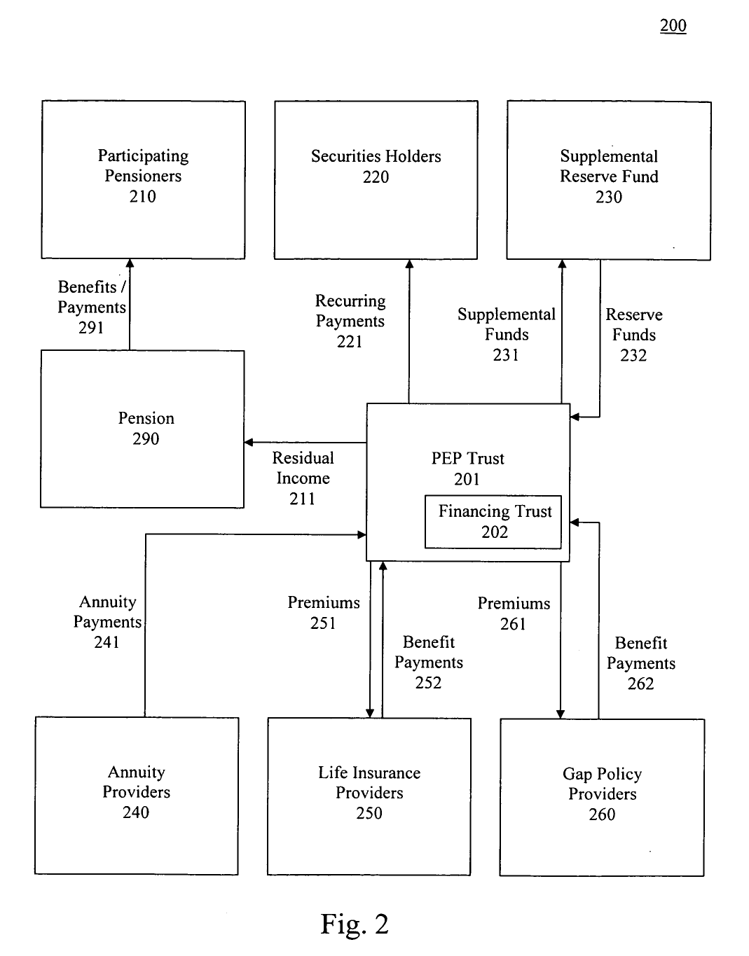

FIG. 2 illustrates some of the ongoing relationships and interactions of PEP 100 after it is established as described above. As shown, PEP 200 is similar to (or the same as) PEP 100 in many respects and includes functional blocks which have been numbered similarly to denote similar functionality and general correspondence. For example, PEP 200 may include PEP trust 201 and financing trust 202 (trusts 101 and 102, in FIG. 1, respectively), participating pensioners 210 (110 in FIG. 1), securities holders 220 (securities holders 120), and pension 290 (pension 190) and involve supplemental reserve fund 230 (fund 130), annuity provider 240, life insurance providers 250, and optionally, gap policy providers 260 (providers 140, 150, and 160, respectively, in FIG. 1).

During ongoing operations, the main source of funding for PEP 200 is periodic annuity payments 241 made to financing trust 202 (or as the case may be, to PEP trust 201) for any living participating pensioners 210. Financing trust 202 may pay for several expenditures associated with PEP 200. These may include, but are not necessarily limited to: (1) recurring payments 221 made to securities holders 220 of securities issued by financing trust 202 (which may differ from the set of securities holders due to sales of the securities or other events); (2) life insurance premiums 251; (3) gap policy premiums 261 (if needed); (4) supplemental funds 231 as needed to potentially maintain the supplemental reserve fund 230 at the desired level of funding; (5) administrative fees (including any applicable taxes and trustee service fees); and (6) residual income 211 to pension 290.

In certain embodiments, payments to security holders 220 may represent substantially all taxable income from the annuity contracts. In addition, financing trust 202 may pay any residual annuity income to PEP trust 201, which may pass some or all of this capital to pension plan 290 and/or the 414k or similar accounts of participating pensioners 210.

There are additional sources of funding for PEP 200. For example, certain events may cause gap policy coverage to be triggered, resulting in benefit payments 262 being made to the financing trust 202. On the death of participating pensioners 210, death benefit payments 252 will be made to the financing trust 202 by life insurance providers 250. Also, if recurring payments 221 need to be paid during the interim between the receipt of the final annuity payment 241 for a deceased participating pensioner 210 and the respective death benefit payment 252, reserve funds 232 may be withdrawn from the supplemental reserve fund 230.

Residual income 211 made available for distribution to the pension 290 may be used to cover operating expenses of pension 290, offer improved benefits 291 to participating pensioners, or more directly shared as cash payments 291 to participating pensioners 210. Thus, positive cash flow is generated from the annuity payments which exceed the cost of the expenses associated with both PEP trust 201 and financing trust 202. This arrangement also maintains the value of the life insurance policies and allows the excess funds to be shared among the participating pensioners 210 and/or the pension 290. Moreover, this additional income is generated for pension 290 without introducing any substantial additional risk to the underlying assets of the plan.

The following table is illustrative of the annual cash flow for funds relating to a 70 year old male participating pensioner:

| | |
|---|---|
| Annuity Income | $51,708 |
| Recurring Payments to | −$33,658 |
| Securities Holders | |
| Life Insurance Premium | −$16,250 |
| Administrative Fees | −$500 |
| Gap Policy Premiums and | −$100 |
| Supplemental Funds | |
| Net Annual Residual Income for | $1,200 |
| Pension | |

The following table illustrates the annual net residual income that may be created and captured by the PEP trust 200 according to a participating pensioner's age and sex. These values were calculated assuming that life insurance was provided by insurance carrier AXA; annuity coverage was provided by American National; the capital market securities were sold at basis points (including investment bank fees); 95% of participating pensioners were standard, and 5% are preferred (preferred participating pensioners have a life expectancy of about 6 months more than standard).

| Age | Male | Female |
|---|---|---|
| 65 | −$563 | −$1,257 |
| 66 | −$396 | −$1,225 |
| 67 | $584 | −$609 |
| 68 | $696 | −$100 |
| 69 | $1,567 | $712 |
| 70 | $1,200 | $604 |
| 71 | $684 | $635 |
| 72 | $1,830 | $1,217 |
| 73 | $2,243 | $1,821 |
| 74 | $2,291 | $1,786 |
| 75 | $2,997 | $2,575 |
| 76 | $3,078 | $2,912 |
| 77 | $2,042 | $2,452 |
| 78 | $2,578 | $2,925 |
| 79 | $1,610 | $2,817 |
| 80 | $2,371 | $3,821 |
| Average | $1,551 | $1,318 |

Death of a Participating Pensioner

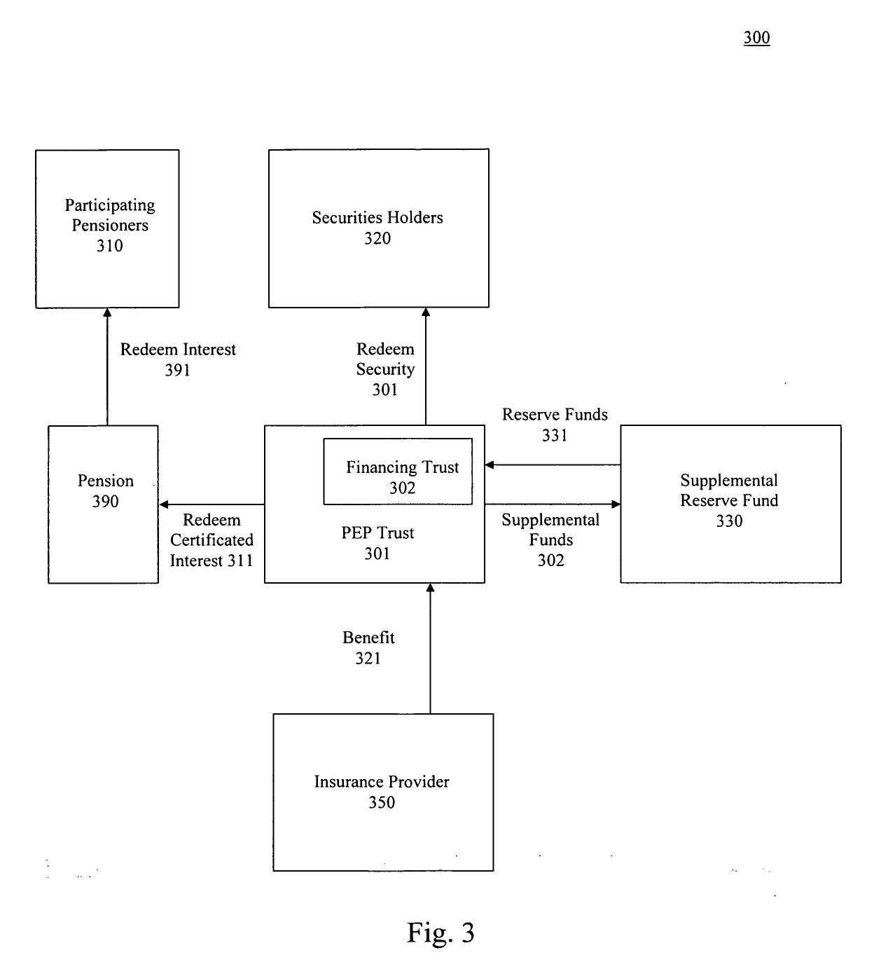

PEP 300 of FIG. 3 illustrates certain actions and events related to the death of a participating pensioner 210 in FIG. 2. As shown, PEP 300 is similar to (or the same as) PEP 200 in many respects and includes functional blocks which have been numbered similarly to denote similar functionality and general correspondence. For example, PEP 300 may include PEP trust 301, financing trust 302, (trusts 201 and 202, in FIG. 2, respectively), security holders 320 (holders 220), and supplemental reserve fund 330 (fund 230).

PEP 300 may maintain life insurance coverage on a participating pensioner 210 until the participating pensioner reaches a certain or his or her death, whichever comes first. When a participating pensioner passes away, two events occur: (1) payments associated with the participating pensioner cease to the paid by the annuity 240 (e.g., due to a life contingent liability), and (2) the insurance provider 350, in this instance the life insurance provider, pays a benefit 321 in the form of death benefit under the insurance policy to the financing trust 302 as the assignee of the life insurance policy.

If in the period between when annuity payments 241 cease and the receipt of the benefit 321 there are recurring payments to be made to securities holders 320, the supplemental reserve fund 330 may provide reserve funds 331 so that these interim recurring payments 231 related to the deceased pensioner can be made. Alternatively, such interim recurring payments 221 may be funded by the gap policy provider, again shown as the insurance provider 350, who provides a benefit 321 under the terms of any gap policy to the financing trust 302 as the owner of the gap policy.

In the event the participating pensioner 310 is still alive and the related life insurance coverage ceases, the annuity with respect to such participating pensioner 310 may also cease making annuity payments. The final annuity payment then serves to end the arrangement with respect to such participating pensioner. In that instance, the annuity provider, again shown as the insurance provider 350, provides the final annuity payments, shown as a benefit 321, under the terms of annuity contract to the financing trust 302 as the owner of the annuity contract.

Once the benefit 321 is made to the PEP trust 300 by the insurance provider 320, there is a security redemption 311, that is the redemption of certificated interest 311 of the PEP trust 301 held by the pension 390 with respect to the participating pensioner on whose behalf the arrangement ends, and the redemption of the interest 391 held by or on behalf of such participating pensioner. In the event of the death of the participating pensioner, the benefit 321 in the form of the death benefit from the life insurance carrier pays back the original funds contributed by the securities holders 320, whose funds were partially used to purchase the annuity contract.

In order to help securities holders 320 regain the original funds contributed by securities holders 320, recurring payments 221 in addition to death benefit may also serve to partially redeem the securities, because depending on the nature of an embodiment of the arrangement, death benefits may not be collected on behalf of every participating pensioners due to participating pensioners longevity and the nature of life insurance coverage term. Supplemental funds 302 may be transferred into supplemental reserve fund 330 to maintain it at the desired level of funding.

Computer Implementation

In some embodiments, some or all of the invention may be implemented by a computer, so as to more effectively and efficiently establish and/or administer particular aspects of the invention. For example, given the large size of some group benefit plans, and the number of factors in evaluating potential participants and various products offered on the insurance markets, it is inefficient to perform such evaluations manually. Thus, some or all of the aspects of the inventions described herein may be performed by a computer and computer code therefore, including establishing and maintaining the various PEP plans 100 200 and 300 described herein.

For example, one or more computer programs may be developed, in the form of source and/or executable code and be disposed on computer readable medium such as a CD ROM, jump drive, or other magnetic or optical storage media for performing or implementing any of the features described herein. Such computer code may also be disposed on a local or personal computer, a network computer or on a remote computer such a server as part of a distributed network such as a WAN or LAN, for certain entity, etc.

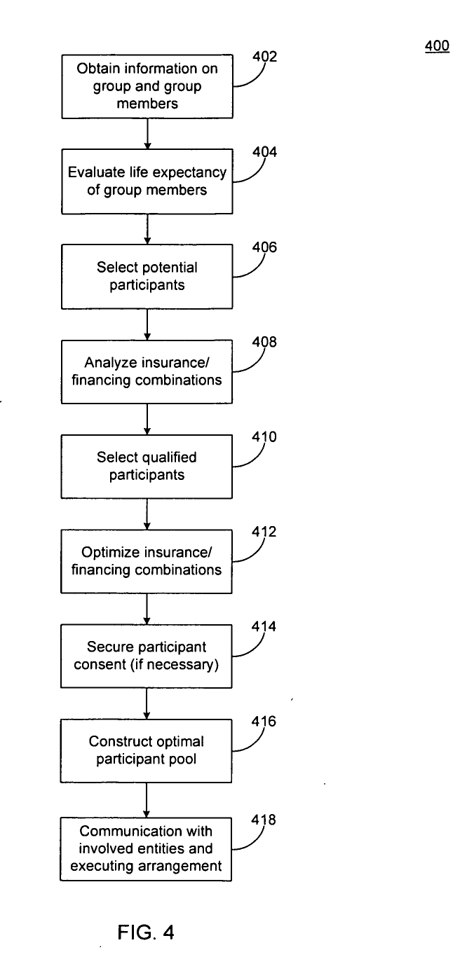

FIG. 4 includes a flow chart 400 representing some of the steps that may be performed by a computer and through one or more application programs in accordance with the principles of the present invention.

At step 402, information regarding the group and/or group benefit plan members, such as demographic information and other personal information such as health information, and insurance information, may be obtained and entered into a database, etc. Such information may already be present in an pre-existing database relating to the benefit plan or other employer database. In this case, the pre-existing database may be used as the basis for performing the following steps. Next, at step 404, this information on the group and/or group members is evaluated to develop a view on life expectancy of the group members.

Next, at step 406, based on the database information and life expectancy, a group of potential participants may be selected in view of one or more initial screening factors such as age, health, etc. to obtain a group for which the arrangement described herein may succeed. For potential participants that satisfy the initial criteria, possible insurance/financing combinations are created and analyzed to determine whether such potential participants qualify (or are suitable for) participation in the arrangement (step 408).

This may include consideration of several different life insurance factors such as policy amount, premiums, mortality, and life expectancy. This information may be obtained from one or more life insurance companies such as Northwestern Mutual or AXA (e.g., through online policy illustrations, secure network computer or may be quoted or customized on request). Financing component considerations may include, for example, annuity payout rates, interest rates, swaps, capital market requirements, cash flow, securities holder payment terms, etc. and may be available online, through a secure network computer or may be quoted or customized on request from various financing concerns such as Jackson National Life or Morgan Stanley.

After such factors have been taken into consideration, a certain number of potential participants are deemed acceptable, and others not acceptable (at step 410). This determination may be based on the likely financial performance of their participation (e.g., based on a threshold which may be set by the group benefit plan or trust). For the group of acceptable participants, one or more insurance/financing combinations may be generated and optimized based on financial performance, risk exposure or other factors (step 412).

Illustrations of such performance may then be generated and communicated to the potential participants as part of an invitation to participate in the plan arrangement in order to secure participant consent (step 414). In jurisdictions where participant consent is not required, step 414 may be skipped, or, in some embodiments, such illustrations may be generated for use by plan management or others. Subsequently, at step 416, a final participant pool of insureds is constructed, optimized under certain financial considerations.

Next at step 418, after participants have agreed to participate (or selected where no consent is required), certain communications with involved parties may occur (e.g., may be generated substantially automatically and may completed by one or more application programs). These may include communicating with the PEP or financing trust management informing them of the new participants and the terms of that participation, communicating with insurance carriers, and applying for and obtaining the applicable insurance, communicating with financing providers, and applying for and obtaining the applicable financing component, communicating details to participant, and carrying out the any of the other tasks as described herein in connection with described inventions.

Although certain specific embodiments of the present invention have been disclosed, it is noted that the present invention may be embodied in other forms without departing from the spirit or essential characteristics thereof. The present embodiments are therefore to be considered in all respects as illustrative and not restrictive, the scope of the invention being indicated by the appended claims, and all changes that come within the meaning and range of equivalency of the claims are therefore intended to be embraced therein.

What is claimed is:

1. A funding and administrative entity for supplementing income to a group benefit plan, comprising:
a trust;
a plurality of participants enrolled in the group benefit plan;
one or more structured finance contracts which provide income to the trust for a predetermined period of time based on lives of the plurality of participants, wherein the trust is designated as the beneficiary of the structured finance contracts;
one or more life insurance contracts that insure lives of the plurality of participants, wherein the trust is designated as the beneficiary of the life insurance contracts; and
one or more security instruments issued by the trust for paying costs associated with securing the one or more annuity or structured finance contracts, and the one or more life insurance contracts, and administrative expenses;
wherein a net income of the trust is transferred to the group benefit plan, and wherein the plurality of participants optionally receive a benefit associated with the net income of the trust.

2. The funding and administrative entity of claim 1 wherein the group benefit plan is a pension plan.

3. The funding and administrative entity of claim 1 wherein the group benefit plan is a VEBA.

4. The funding and administrative entity of claim 1 wherein the structured finance contract is a life annuity.

5. The funding and administrative entity of claim 1 wherein the structured finance contract is a non-life contingent contracted purchased from an insurance carrier.

6. The funding and administrative entity of claim 1 wherein the structured finance contract is a synthetic or derivative financing instrument.

7. The funding and administrative entity of claim 6 wherein the structured finance contract is a mortality swap instrument.

8. The funding and administrative entity of claim 1 wherein the trust is a Delaware statutory trust.

9. The funding and administrative entity of claim 1 wherein the further comprising a financing trust.

10. The funding and administrative entity of claim 9 wherein the financing trust handles a least some transactions associated with the one or more life insurance contracts.

11. The funding and administrative entity of claim 9 wherein the financing trust handles at least some transactions associated with the one or more structured finance contracts.

12. A method for supplementing a group benefit plan comprising:
creating a trust;
selecting a plurality of potentially qualified group benefit plan participants based on expected successful combination of structured finance and life insurance products;
selecting a plurality of qualified group benefit plan participants from the plurality of potentially qualified group benefit plan participants;
obtaining one or more life insurance contracts on the lives of the a plurality of qualified group benefit plan participants with the trust designated as the beneficiary of the life insurance contracts;
obtaining one or more annuity contracts on the lives of the qualified group benefit plan participants, with the trust entity as the beneficiary of said annuity contracts;
issuing one or more capital market security instruments to pay for costs associated with securing one or more structured finance contracts, one or more life insurance contracts, one or more gap insurance policies, and administrative expenses; and
transferring a net income of the trust to the pension plan; and optionally conveying a benefit associated with the net income to the participating pensioners or to the group benefit plan.

13. The method of claim 12 wherein the plurality of potentially qualified group benefit plan participants are selected, at least in part, based on age.

14. The method of claim 12 wherein the plurality of potentially qualified group benefit plan participants are selected, at least in part, based on health.

15. The method of claim 12 further comprising seeking consent from the plurality of qualified group benefit plan participants to obtain the one or more life insurance contracts.

16. The method of claim 12 wherein the group benefit plan is a pension plan.

17. The method of claim 12 wherein the group benefit plan is a VEBA.

18. The method of claim 12 wherein the one or more structured finance contracts are a life annuity.

19. The method of claim 12 wherein the one or more structured finance contracts are a synthetic or derivative financing instruments.

20. The method of claim 19 wherein the structured finance contract is a mortality swap instrument.

21. The method of claim 12 wherein the trust is a Delaware statutory trust.

22. The of claim 12 wherein the further comprising creating a financing trust.

23. The method of claim 22 wherein the financing trust handles a least some transactions associated with the one or more life insurance contracts.

24. The method of claim 22 wherein the financing trust handles a least some transactions associated with the one or more structured finance contracts.

25. A computer-readable medium having stored thereon a plurality of sequences of instructions including sequences of instructions which, when executed by one or more processors cause an electronic device to:
select a plurality of potentially qualified group benefit plan participants based on an expected successful combination of structured finance and life insurance products;
obtain information regarding one or more life insurance contracts on the lives of the plurality of potentially qualified group benefit plan participants;
obtain information regarding one or more annuity contracts on the lives of the plurality of potentially qualified group benefit plan participants; and
select a plurality of qualified group benefit plan participants from the plurality of potentially qualified group benefit plan participants.

26. The computer-readable medium of claim 25 wherein selecting the plurality of qualified group benefit plan participants further comprises creating a life insurance contract and annuity contract combination for potentially qualified group benefit plan participants.

27. The computer-readable medium of claim 26 wherein the life insurance contract and annuity contract combination is analyzed to determine whether such potential participants are qualified.
